(19) United States
(12) Patent Application Publication
(10) Pub. No.: US 2026/0106077 A1
(43) Pub. Date: Apr. 16, 2026

(54) MULTILAYER CERAMIC CAPACITOR AND METHOD OF MANUFACTURING THE SAME

(71) Applicant: SAMSUNG ELECTRO-MECHANICS CO., LTD., Suwon-si (KR)

(72) Inventors: Sumin Shin, Suwon-si (KR); Hongseok Kim, Suwon-si (KR); Dojeon Kim, Suwon-si (KR); Sunghwan Lee, Suwon-si (KR); Jihye Ahn, Suwon-si (KR)

(73) Assignee: SAMSUNG ELECTRO-MECHANICS CO., LTD., Suwon-si (KR)

(21) Appl. No.: 19/072,582

(22) Filed: Mar. 6, 2025

(30) Foreign Application Priority Data
Oct. 16, 2024 (KR) 10-2024-0141009

(51) Int. Cl. H01G 4/12; H01G 4/008; H01G 4/232; H01G 4/30

(52) U.S. Cl. CPC H01G 4/1254; H01G 4/008; H01G 4/232; H01G 4/30

(57) ABSTRACT

Provided are a multilayer ceramic capacitor and a method of manufacturing the same, the multilayer ceramic capacitor including a capacitor body including a plurality of dielectric layers and a plurality of internal electrode layers stacked with the dielectric layers interposed therebetween; and an external electrode disposed on an outer surface of the capacitor body, wherein the internal electrode layer includes a metal layer and an insulating layer disposed at an interface with the dielectric layer on a surface of the metal layer, the insulating layer includes an oxide including tantalum (Ta), and the oxide is represented by Chemical Formula 1.

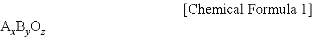

In Chemical Formula 1, A, B, x, y, and z are as defined in the specification.

### CROSS-REFERENCE TO RELATED APPLICATION

This application claims priority to and the benefit of Korean Patent Application No. 10-2024-0141009 filed in the Korean Intellectual Property Office on Oct. 16, 2024, the entire contents of which are incorporated herein by reference.

### BACKGROUND

### (a) Technical Field

The present disclosure relates to a multilayer ceramic capacitor and a method of manufacturing the same.

### (b) Description of the Related Art

As electronic components using a ceramic material, there are a capacitor, an inductor, a piezoelectric element, a varistor, a thermistor, and the like. Among ceramic electronic components, a multilayer ceramic capacitor (MLCC) may be used in various electronic devices due to advantages such as a small size, a high capacitance, an easy mounting feature, and the like.

For example, a multilayer ceramic capacitor may be used in a chip type condenser mounted on a board of several electronic products such as image devices, for example, liquid crystal displays (LCD), plasma display panels (PDP), or the like, computers, personal portable terminals, smartphones, and the like, to serve to charge or discharge electricity therein or therefrom.

Recently, smaller and larger multilayer ceramic capacitors are required to improve the performance of electronic products. Accordingly, thinning and multi-layering of dielectrics and internal electrodes are being attempted in various ways, multilayer ceramic capacitors are being manufactured with increasing number of layers while the dielectric thickness is getting thinner. However, this thinning of the dielectric increases the electric field intensity per unit area, which causes a decrease in durability due to deterioration of high-temperature reliability of the multilayer ceramic capacitor.

### SUMMARY

Some embodiments of the present disclosure provides a multilayer ceramic capacitor having excellent high-temperature reliability and durability.

Another embodiments provide a method of manufacturing a multilayer ceramic capacitor.

Some embodiments of the present disclosure provides a multilayer ceramic capacitor including a capacitor body including a plurality of dielectric layers and a plurality of internal electrode layers stacked with the dielectric layers interposed therebetween; and an external electrode disposed on an outer surface of the capacitor body, wherein the internal electrode layer includes a metal layer and an insulating layer disposed at an interface with the dielectric layer on a surface of the metal layer, the insulating layer includes an oxide including tantalum (Ta), and the oxide is represented by Chemical Formula 1.

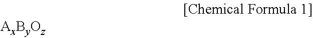

In Chemical Formula 1, A includes Ni, B includes Ta, 0≤x≤0.2, 0.2≤y≤0.5, and x+y+z=1.

The oxide may include at least one selected from the group consisting of Ta₂O₅, TaO₂, and NiTa₂O₆.

The metal layer may include nickel (Ni) and/or tantalum (Ta).

A content of tantalum (Ta) in the insulating layer may be higher than in the metal layer.

When a content of tantalum (Ta) included in the insulating layer is X and a content of tantalum (Ta) included in the metal layer is Y, Equation 1 may be satisfied.

$$0 < ( \vert X - Y \vert ) / X \leq 1 \qquad [ Equation 1 ]$$

The metal layer may include greater than 0 and less than or equal to about 15 parts by atom of tantalum (Ta) based on 100 parts by atom of nickel (Ni).

The insulating layer may include tantalum (Ta) in an amount of about 30 atomic % to about 100 atomic % based on a total amount of the insulating layer.

An average thickness of the insulating layer may be about 0.5 nm to about 6.0 nm.

The insulating layer may be disposed at the interface with the dielectric layer in the stacking direction in the internal electrode layer.

The insulating layer may be disposed at the interface with the dielectric layer in a direction perpendicular to the stacking direction in the internal electrode layer.

The insulating layer may be disposed at the interface with the dielectric layer in the stacking direction and in the direction perpendicular to the stacking direction in the internal electrode layer.

The insulating layer may be further disposed at an interface with the external electrode in a direction perpendicular to the stacking direction in the internal electrode layer.

When analyzing a TEM-EDS (Transmission Electron Microscopy-Energy Dispersive Spectroscopy) line along a straight line from a point in the dielectric layer to a point in an internal electrode layer adjacent to the dielectric layer, an atomic % of tantalum (Ta) in the insulating layer may have a maximum value.

Another embodiment provides a method for manufacturing a multilayer ceramic capacitor, including: mixing nickel (Ni) and tantalum (Ta)-based raw materials to prepare a conductive paste; manufacturing a dielectric green sheet using a dielectric slurry, and printing the conductive paste on a surface of the dielectric green sheet to form a conductive paste layer; manufacturing a dielectric green sheet stack by stacking the dielectric green sheet on which the conductive paste layer is formed; firing the dielectric green sheet stack to manufacture a capacitor body including a plurality of dielectric layers and a plurality of internal electrode layers stacked with the dielectric layers interposed therebetween; and forming an external electrode on an outer surface of the capacitor body, wherein the internal electrode layer includes a metal layer and an insulating layer disposed at an interface with the dielectric layer on a surface of the metal layer, and the insulating layer includes an oxide including tantalum (Ta) and represented by Chemical Formula 1.

The tantalum (Ta)-based raw material may include at least one selected from the group consisting of tantalum (Ta) and tantalum (Ta) oxide, and the tantalum (Ta) oxide may include at least one selected from the group consisting of Ta₂O₅ and TaO₂.

The tantalum (Ta)-based raw material may be included in the dielectric layers in an amount of about 0.6 part by weight to about 12.0 parts by weight based on 100 parts by weight of nickel (Ni).

A multilayer ceramic capacitor according to an embodiment can have excellent high-temperature reliability and durability because defects at the interface between a dielectric layer and an internal electrode layer are prevented.

### BRIEF DESCRIPTION OF THE DRAWINGS

FIG. 1 is a perspective view showing a multilayer ceramic capacitor according to an embodiment.

FIG. 2 is a cross-sectional view of the multilayer ceramic capacitor taken along line I-I′ of FIG. 1.

FIG. 3 is a cross-sectional view of the multilayer ceramic capacitor taken along line II-II′ of FIG. 1.

FIG. 4 is an exploded perspective view illustrating the stacked structure of the internal electrode layers in the capacitor body of FIG. 1.

FIG. 5 is a TEM-EDS (transmission electron microscopy-energy dispersive spectroscopy) mapping analysis photograph of the active region according to Example 1.

FIGS. 6A and 6B are an image and a graph of TEM-EDS (transmission electron microscopy-energy dispersive spectroscopy) line profile analysis for the active region according to Example 1.

FIG. 7 is an X-ray diffraction analysis (XRD) graph for the internal electrode layer according to Example 1.

### DETAILED DESCRIPTION

Hereinafter, the present disclosure will be described in detail hereinafter with reference to the accompanying drawings, in which embodiments of the present disclosure are shown. The drawings and description are to be regarded as illustrative in nature and not restrictive. Like reference numerals designate like elements throughout the specification. In the accompanying drawings, some components are exaggerated, omitted, or schematically illustrated, and the size of each component does not entirely reflect the actual size.

The accompanying drawings are intended only to facilitate an understanding of the embodiments disclosed in this specification, and it is to be understood that the technical ideas disclosed herein are not limited by the accompanying drawings and include all modifications, equivalents, or substitutions that are within the range of the ideas and technology of the present disclosure.

Although terms of “first,” “second,” and the like are used to explain various components, the components are not limited to such terms. These terms are only used to distinguish one component from another component.

In addition, it will be understood that when an element such as a layer, film, region, or substrate is referred to as being “on” another element, it can be directly on the other element or intervening elements may also be present. In contrast, when an element is referred to as being “directly on” another element, there are no intervening elements present. Further, when an element is referred to as being “on” or “above” a reference element, it can be positioned above or below the reference element, and it is not necessarily referred to as being positioned “on” or “above” in a direction opposite to gravity.

Throughout the specification, the terms “comprise” or “have” are intended to specify the presence of stated features, integers, steps, operations, components, components or a combination thereof, but do not preclude the presence or addition of one or more other features, integers, steps, operations, components, components, and/or groups thereof. Therefore, unless explicitly described to the contrary, the word “comprise” and variations such as “comprises” or “comprising” will be understood to imply the inclusion of stated elements but not the exclusion of any other elements.

Further, throughout the specification, the phrase “in a plan view” or “on a plane” means viewing a target portion from the top, and the phrase “in a cross-sectional view” or “on a cross-section” means viewing a cross-section formed by vertically cutting a target portion from the side.

Throughout the specification, the term “connected” does not mean only that two or more constituent components are directly connected, but may also mean that two or more constituent components are indirectly connected through another constituent component, that two or more components are electrically connected as well as physically connected, or that two or more constituent components are referred to by different names but are united by location or function.

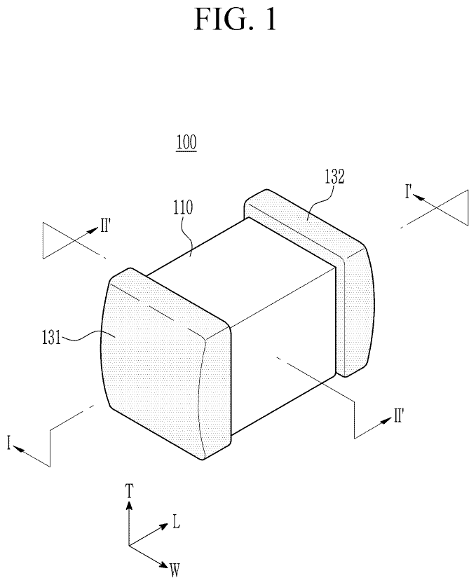

Hereinafter, a multilayer ceramic capacitor according to an embodiment will be described with reference to FIGS. 1 to 4.

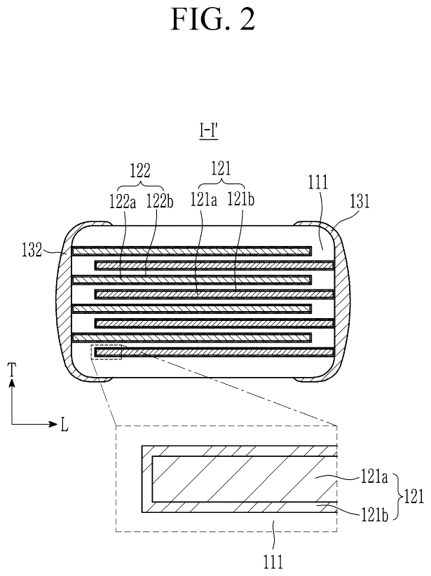

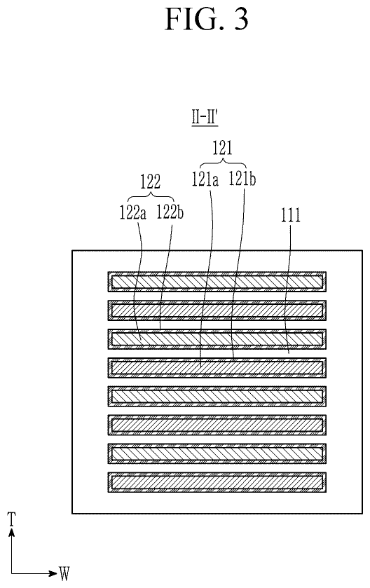

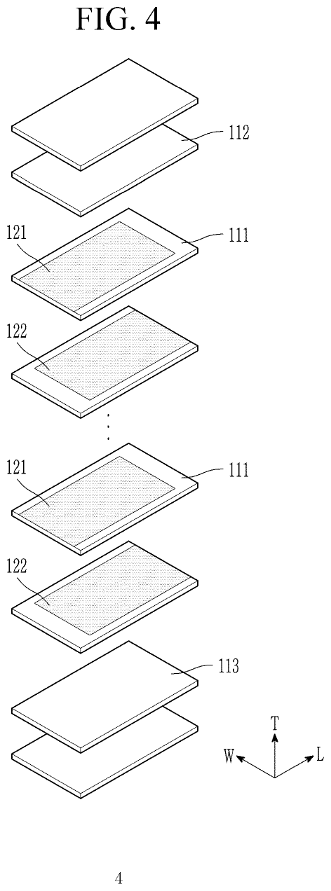

FIG. 1 is a perspective view showing a multilayer ceramic capacitor according to an embodiment, FIG. 2 is a cross-sectional view of a multilayer ceramic capacitor taken along line I-I′ of FIG. 1, FIG. 3 is a cross-sectional view of a multilayer ceramic capacitor taken along line II-II′ of FIG. 1, and FIG. 4 is an exploded perspective view illustrating the stacked structure of the internal electrode layers in the capacitor body of FIG. 1.

The L-axis, W-axis, and T-axis shown in FIGS. 1 to 4 represent a length direction, a width direction, and a thickness direction of a capacitor body 110, respectively. Here, the thickness direction (T-axis direction) may be a direction perpendicular to the wide surface (major surface) of the sheet-shaped components, and may be used as the same concept as a stacking direction in which a dielectric layer 111 are stacked, for example. The length direction (L-axis direction) may be a direction extending parallel to the wide surface (major surface) of the sheet-shaped components, and may be approximately perpendicular to the thickness direction (T-axis direction). For example, the length direction (L-axis direction) may be the direction in which an external electrode 131 and a second external electrode 132 are positioned. The width direction (W-axis direction) may be a direction extending parallel to the wide surface (major surface) of the sheet-shaped components, and may be approximately perpendicular to the thickness direction (T-axis direction) and the length direction (L-axis direction). The length of the sheet-shaped components in the length direction (L-axis direction) may be longer than the length in the width direction (W-axis direction).

Referring to FIGS. 1 to 4, a multilayer ceramic capacitor 100 according to some embodiments of the present disclosure includes the capacitor body 110 and external electrodes 131 and 132 disposed an outer surface the capacitor body 110. The external electrodes 131 and 132 may include a first external electrode 131 and a second external electrode 132 disposed at opposite ends of the capacitor body 110 in the length direction (L-axis direction).

For example, the capacitor body 110 may have a roughly hexahedral shape.

For convenience of description of an embodiment, the two surfaces opposing each other in the thickness direction (T-axis direction) of the capacitor body 110 are referred to as first and second surfaces, the two surfaces connected to the first and second surfaces and opposing each other in the length direction (L-axis direction) are referred to as third and the fourth surfaces, and two surfaces connected to the first and second surfaces and to the third and fourth surfaces, and opposing each other in the width direction (W-axis direction) are referred to as the fifth and sixth surfaces.

In some embodiments, the first surface, which is the lower surface, may be a surface facing the mounting direction. Additionally, the first to the sixth surfaces may be flat, but the embodiment is not limited thereto. For example, the first to the sixth surfaces may be curved surfaces with a convex central portion, and the edges, which are the boundaries of each surface, may be rounded.

The shape and size of the capacitor body 110 and the number of stacks of the dielectric layers 111 are not limited to those shown in the drawings of the embodiment.

The capacitor body 110 includes a plurality of dielectric layers 111 and internal electrode layers 121 and 122. Specifically, the capacitor body 110 includes the plurality of dielectric layers 111 and a first internal electrode layer 121 and a second internal electrode layer 122 alternately disposed in the thickness direction (T-axis direction) interposing the dielectric layer 111.

At this time, the boundaries between adjacent dielectric layers 111 of the capacitor body 110 may be integrated to the extent that it is difficult to check without using a scanning electron microscope (SEM).

The capacitor body 110 may include an active region and cover regions 112 and 113.

The active region is a region where the dielectric layer 111 and the internal electrode layers 121 and 122 are alternately disposed, which contributes to forming capacitance of the multilayer ceramic capacitor 100. Specifically, the active region may be a region where the first internal electrode layer 121 and the second internal electrode layer 122 stacked along the thickness direction (T-axis direction) overlap.

The cover regions 112 and 113 are thickness-direction marginal portions, and may be positioned on the first and second surfaces of the capacitor body 110 in the thickness direction (T-axis direction), respectively. The cover regions 112 and 113 may be a single dielectric layer 111 or two or more dielectric layers 111 stacked on the upper and lower surfaces of the active region, respectively.

Additionally, the capacitor body 110 may further include a side margin region.

The side margin region is a width-direction margin portion and may be positioned on opposite side ends of the active region in the width direction (W-axis direction), that is, on the fifth surface and the sixth surface, respectively. The side margin region may be formed the dielectric green sheets are stacked and then fired, when the conductive paste layer for the internal electrode is applies on a surface of a dielectric green sheet, and the dielectric green sheets for the side margin region may be applied with the conductive paste layer only in a partial region of the surface of the dielectric green sheet and not applied with the conductive paste layer on both side surfaces of the surface of the dielectric green sheet. The method of forming the side margin region is not limited thereto.

The cover regions 112 and 113 and the side margin region serve to prevent damage to the first internal electrode layer 121 and the second internal electrode layer 122 due to physical or chemical stress.

Hereinafter, each of the internal electrode layer, dielectric layer, and external electrode is described in detail.

### Internal Electrode Layer

The internal electrode layers 121 and 122, i.e., the first internal electrode layer 121 and the second internal electrode layer 122, are electrodes having different polarities and are alternately disposed to face each other along the T-axis direction with the dielectric layer 111 interposed between them, and one end may be exposed through the third and fourth surfaces of the capacitor body 110, respectively.

The first internal electrode layer 121 and the second internal electrode layer 122 may be electrically insulated from each other by a dielectric layer 111 disposed therebetween.

One end of the first internal electrode layer 121 and on end of the second internal electrode layer 122, which are alternately exposed through the third and fourth surfaces of the capacitor body 110, may be electrically connected to the first external electrode 131 and the second external electrode 132, respectively.

Referring to FIG. 2, the internal electrode layers 121 and 122 according to some embodiments may include metal layers 121a and 122a and insulating layers 121b and 122b disposed at the interface with the dielectric layer 111 on the surface of the metal layers 121a and 122a, respectively. Specifically, the first internal electrode layer 121 may include a first metal layer 121a and a first insulating layer 121b on the surface of the first metal layer 121a, and the second internal electrode layer 122 includes a second metal layer 122a and a second insulating layer 122b on the surface of the second metal layer 122a.

The insulating layers 121b and 122b may include an oxide including tantalum (Ta). The oxide may be represented by Chemical Formula 1.

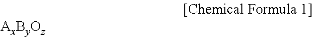

In Chemical Formula 1, A includes Ni, B includes Ta, 0≤x≤0.2, 0.2≤y≤0.5, and x+y+z=1.

Typically, when manufacturing a multilayer ceramic capacitor, a conductive paste is printed on a dielectric green sheet to form a conductive paste layer, and then a dielectric green sheet stack is formed. The dielectric green sheet stack becomes a multilayer ceramic capacitor composed of an internal electrode layer and a dielectric layer through a calcining and firing process. However, when the main component of the internal electrode layer is nickel (Ni), defects occurring at the interface between the internal electrode layer and the dielectric layer weaken the high-temperature reliability and durability of the multilayer ceramic capacitor.

According to some embodiments of the present disclosure, the internal electrode layers 121 and 122 have insulating layers 121b and 122b, respectively, including an oxide including tantalum (Ta) at the interface with the dielectric layer 111, thereby delaying the entry of carriers into the conduction band and preventing the formation of a metal-dielectric junction at the interface between the internal electrode layers and the dielectric layer, and thus preventing the occurrence of defects. Accordingly, a multilayer ceramic capacitor with a thinner dielectric layer can reduce leakage current and secure a multilayer ceramic capacitor with excellent durability due to excellent high-temperature load life-span.

Specifically, the insulating layers 121b and 122b may be a barrier layer that impedes the movement of electrons and can prevent the formation of a junction between the metal of the internal electrode layer and the dielectric layer having semiconductor characteristics at the interface between the internal electrode layer and the dielectric layer. That is, the insulating layers 121b and 122b may reduce leakage current by interfering with the metal-dielectric junction and preventing carriers from entering the conduction band as it is placed between the internal electrode layer and the dielectric layer.

In Chemical Formula 1, A may further include Cu, Ag, Pd, or Au, and B may further include Sn, Bi, In, Zn, or Pb.

The oxide included in the insulating layers 121b and 122b may specifically include one or more selected from Ta₂O₅, TaO₂, and NiTa₂O₆.

The oxide of the insulating layer may be derived by firing a conductive paste including nickel (Ni) as the main component and tantalum (Ta)-based raw materials added. During the firing process, some of the tantalum (Ta)-based raw materials can form NiTa₂O₆ through a chemical reaction with nickel (Ni), and some of them can move to the surface of the internal electrode layer to form an insulating layer at the interface between the dielectric layer and the internal electrode layer.

The oxide may have higher band gap energies than the BaTiO₃ dielectric. The size of the band gap provides an energy barrier sufficient to prevent electrons from being ionized and jumping directly into the conduction band. Additionally, the oxides may minimize direct tunneling and F-N (Fowler-Nordheim) tunneling effects of carriers.

The insulating layers 121b and 122b allows the current to flow through the band gap and through a conduction path that includes defects within the band gap, rather than through the conduction band across the band gap of the dielectric. Carriers passing through these defect paths within the band gap require more energy to move, and the flow of current is impeded.

The metal layers 121a and 122a includes nickel (Ni) as a main component and may also include tantalum (Ta).

That is, tantalum (Ta) may be included in both the insulating layers 121b and 122b and the metal layers 121a and 122a. According to some embodiments, the content of tantalum (Ta) may be higher in the insulating layers 121b and 122b than in the metal layers 121a and 122a. In other words, the tantalum (Ta) content may be higher at the interface than in the inner region in the internal electrode layer. In this case, the formation of a metal-dielectric junction at the interface between the internal electrode layer and the dielectric layer may be prevented by delaying the entry of carriers into the conduction band, thereby preventing the occurrence of defects. Accordingly, the leakage current of the multilayer ceramic capacitor with a thinner dielectric layer may be reduced, and a multilayer ceramic capacitor with excellent high-temperature reliability and durability may be secured.

Specifically, when the content of tantalum (Ta) included in the insulating layers 121b and 122b is X and the content of tantalum (Ta) included in the metal layers 121a and 122a is Y, Equation 1 may be satisfied.

$$0 < ( \vert X - Y \vert ) / X \leq 1 \qquad [ Equation 1 ]$$

The metal layers 121a and 122a may include tantalum (Ta) in an amount greater than 0 and less than or equal to about 15 parts by atom, for example, about 0.1 parts by atom to about 14 parts by atom, about 0.5 parts by atom to about 13 parts by atom, about 1 part by atom to about 12 parts by atom, about 1.5 parts by atom to about 11 parts by atom, or about 2 parts by atom to about 10 parts by atom based on 100 parts by atom of nickel (Ni). When the tantalum (Ta) content in the metal layer is within the above range, the high-temperature reliability and durability of the multilayer ceramic capacitor may be improved.

In addition to nickel (Ni), the metal layers 121a and 122a may further include one or more conductive metals selected from the group consisting of copper (Cu), silver (Ag), palladium (Pd), gold (Au), and an alloy thereof.

The insulating layers 121b and 122b may include tantalum (Ta) in an amount of about 30 atomic % to about 100 atomic %, for example, about 40 atomic % to about 95 atomic %, or about 50 atomic % to about 90 atomic % based on a total amount of the insulating layer. When the tantalum (Ta) content in the insulating layers 121b and 122b is within the above range, carriers are delayed from entering the conduction band, thereby preventing the formation of a metal-dielectric junction at the interface between the internal electrode layer and the dielectric layer, and thus preventing the occurrence of defects. Accordingly, the high-temperature reliability and durability of the multilayer ceramic capacitor can be improved.

An average thickness of the insulating layers 121b and 122b may be about 0.5 nm to about 6.0 nm, for example, about 0.7 nm to about 5.8 nm, about 0.9 nm to about 5.6 nm, about 1.1 nm to about 5.4 nm, or about 1.3 nm to about 5.2 nm. When the thickness of the insulating layer is within the above range, the occurrence of defects at the interface between the internal electrode layer and the dielectric layer can be prevented, thereby obtaining a multilayer ceramic capacitor having excellent high-temperature reliability and durability.

The average thickness of the insulating layers 121b and 122b can be confirmed by transmission electron microscopy (TEM) analysis.

In more detail, after the multilayer ceramic capacitor 100 was placed into an epoxy mixing solution and then cured, the W-axis and the T-axis directional surface (WT surface) of the capacitor body 110 was polished to ½ depth in the L-axis direction, and then by fixing and maintaining it in the vacuum atmosphere chamber, a cross-sectional sample may be obtained such that the active region where the dielectric layer 111 and the internal electrode layers 121 and 122 intersect may be observed. Next, it may be measured using a transmission electron microscope (TEM) so that at least 1 layer, 3 layers, 5 layers, or 10 layers of the internal electrode layers for the active region of the cross-sectional sample are visible. TEM may be measured under conditions of an acceleration voltage of 200 kV using a Xe-FIB (focused ion beam). In a scanning electron microscope (SEM) image of a measured cross-sectional sample, the central point in the length direction (L-axis direction) or the width direction (W-axis direction) of the first insulating layer 121b or the second insulating layer 122b is used as a reference point, and the arithmetic mean value of the thickness of the first insulating layer 121b or the second insulating layer 122b at 10 points spaced apart from the reference point by a predetermined interval can be obtained. The intervals of the 10 points may be adjusted depending on the scale of the scanning electron microscope (SEM) image, and may be, for example, about 1 μm to about 100 μm, about 1 μm to about 50 μm, or about 1 μm to about 10 μm. At this time, all 10 points should be positioned within the first insulating layer 121b or the second insulating layer 122b, and if all 10 points are not positioned within the first insulating layer 121b or the second insulating layer 122b, the position of the reference point may be changed, or the interval between the 10 points may be adjusted.

Additionally, the internal electrode layers 121 and 122 may include dielectric particles having the same composition as the ceramic material included in the dielectric layer 111.

The structure of the internal electrode layers 121 and 122 according to an embodiment may be specifically explained with reference to FIG. 2.

Referring to FIG. 2, the insulating layers 121b and 122b may be disposed at the interface with the dielectric layer 111 in the stacking direction, i.e., the thickness direction (T-axis direction) in the internal electrode layers 121 and 122. In addition, the insulating layers 121b and 122b may be disposed at the interface with the dielectric layer 111 in the vertical direction of the stacking direction, i.e., in the length direction (L-axis direction) of the internal electrode layers 121 and 122. Additionally, it may be disposed at the interface with the dielectric layer 111 in both directions described above. Additionally, the insulating layers 121b and 122b may be further disposed at an interface with the external electrodes 131 and 132 in the vertical direction of the stacking direction in the internal electrode layers 121 and 122.

For example, the insulating layers 121b and 122b may have a structure that surrounds the entire surface of the metal layers 121a and 122a. Although FIG. 2 illustrates a structure in which an insulating layers 121b and 122b surrounds the entire surface of a metal layers 121a and 122a, this is only an example of a structure for convenience. An embodiment is not limited to FIG. 2, as long as the insulating layer has a structure in which it is disposed at the interface with the dielectric layer on the surface of the metal layer. In some embodiments, the insulating layers 121b and 122b may be disposed on a part of the interface with the dielectric layer on the surface of the metal layer.

The structure of the metal layers 121a and 122a and the insulating layers 121b and 122b of the internal electrode layers 121 and 122 and the components forming the metal layer and the insulating layer can be confirmed through TEM-EDS (transmission electron microscopy-energy dispersive spectroscopy) analysis.

In more detail, after the multilayer ceramic capacitor 100 was placed into an epoxy mixing solution and then cured, the W-axis and the T-axis directional surface (WT surface) of the capacitor body 110 was polished to ½ depth in the L-axis direction, and then by fixing and maintaining it in the vacuum atmosphere chamber, a cross-sectional sample may be obtained such that the active region where the dielectric layer 111 and the internal electrode layers 121 and 122 intersect may be observed. Next, the active region of the cross-sectional sample can be measured using a transmission electron microscope (TEM) so that at least one dielectric layer and at least one internal electrode layer are visible. For example, when the active region of a cross-sectional sample is divided into three portions, the upper portion, the middle portion, and the lower portion, it can be measured by TEM so that at least one dielectric layer and at least one internal electrode layer are visible in each region. TEM may be measured under conditions of an acceleration voltage of 200 kV using a Xe-FIB (focused ion beam).

Subsequently, the TEM image of the cross-sectional sample may be subjected to EDS (energy dispersive spectroscopy) mapping analysis, and in addition, an EDS (energy dispersive spectroscopy) line analysis may be performed on a straight line section from one point of any dielectric layer to another point of an internal electrode layer adjacent to the dielectric layer. Through the EDS mapping analysis and the EDS line analysis, structures and components in the metal layers 121a and 122a and the insulating layers 121b and 122b of the internal electrode layer may be checked.

According to this TEM-EDS line analysis, the metal layers 121a and 122a according to some embodiments may be a region where nickel (Ni) has maximum atomic % within the internal electrode layer, and the insulating layers 121b and 122b may be a region where tantalum (Ta) has maximum atomic % within the internal electrode layer.

In addition, tantalum (Ta) included in the insulating layer of the internal electrode layer according to some embodiments may be present in the form of oxide, which may be confirmed by X-ray diffraction (XRD) analysis of the internal electrode layer.

Specifically, after the multilayer ceramic capacitor 100 may be put in an epoxy mixing solution and cured, a W-axis and T-axis direction surface (WT surface) of its capacitor body 110 may be polished to a ½ depth in a L-axis direction and maintained in a vacuum atmosphere chamber, obtaining a cross-sectional sample to examine an active region where the dielectric layer and internal electrode layer intersect each other. Subsequently, the internal electrode layer in the active region of the cross-sectional sample may be subjected to X-ray diffraction (XRD) analysis by using Cu K_{α} rays. For example, the active region of the cross-sectional sample is divided into three portions such as upper, central, and lower portions, and in each of these portions, the internal electrode layer may be subjected to the X-ray diffraction (XRD) analysis by using Cu K_{α} rays.

An average thickness of the internal electrode layers 121 and 122 may be about 0.1 μm to about 2 μm, for example about 0.1 μm to about 1 μm. When the average thickness of the internal electrode layers 121 and 122 is within the above range, the reliability of the multilayer ceramic capacitor is excellent.

The average thickness of the internal electrode layers 121 and 122 may be measured by placing the multilayer ceramic capacitor 100 in an epoxy mixing solution, curing it, polishing it, and then ion milling it, and then analyzing it using a scanning electron microscope (SEM). A scanning electron microscope can be used, for example, using a Verios G4 product from Thermofisher Scientific, with measurement conditions of 10 kV and 0.2 nA, an analysis magnification of 100 times, and may be measured for at least 1 layer, 3 layers, 5 layers, or 10 layers or more of internal electrode layers. In a scanning electron microscope (SEM) image of a measured cross-sectional sample, the central point in the length direction (L-axis direction) or the width direction (W-axis direction) of the first internal electrode layer 121 or the second internal electrode layer 122 is used as a reference point, and the arithmetic mean value of the thickness of the first internal electrode layer 121 or the second internal electrode layer 122 at 10 points spaced apart from the reference point by a predetermined interval can be obtained. The intervals of the 10 points may be adjusted depending on the scale of the scanning electron microscope (SEM) image, and may be, for example, about 1 μm to about 100 μm, about 1 μm to about 50 μm, or about 1 μm to about 10 μm. At this time, all 10 points should be positioned within the first internal electrode layer 121 or the second internal electrode layer 122, and if all 10 points are not positioned within the first internal electrode layer 121 or the second internal electrode layer 122, the location of the reference point can be changed or the interval between the 10 points can be adjusted.

### Dielectric Layer

According to some embodiments, the dielectric layer 111 may include a barium titanate-based compound including barium (Ba) and titanium (Ti) as a main component.

The barium titanate-based compound is a dielectric base material, have high permittivity, and contribute to forming the permittivity of multilayer ceramic capacitors 100.

For example, the barium titanate-based compound may include at least one selected from the group consisting of BaTiO₃, Ba(Ti,Zr)O₃, Ba(Ti, Sn)O₃, (Ba, Ca)TiO₃, (Ba, Ca)(Ti, Zr)O₃, (Ba, Ca)(Ti, Sn)O₃, (Ba, Sr)TiO₃, (Ba, Sr)(Ti, Zr)O₃ and (Ba, Sr)(Ti, Sn)O₃.

The dielectric layer 111 may further include a subcomponent. The subcomponent may further include one or more selected from the group consisting of, for example, manganese (Mn), chromium (Cr), silicon (Si), aluminum (AI), magnesium (Mg), tin (Sn), antimony (Sb), germanium (Ge), gallium (Ga), indium (In), barium (Ba), lanthanum (La), yttrium (Y), actinium (Ac), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), hafnium (Hf), and vanadium (V).

An average thickness (average length in the T-axis direction) of the dielectric layer 111 may be about 0.1 μm to about 8.0 μm, and for example, may be about 0.1 μm to about 6.0 μm, or about 0.1 μm to about 2.0 μm. When the average thickness of the dielectric layer 111 is within the above range, the reliability of the multilayer ceramic capacitor may be improved.

As described above, in a scanning electron microscope (SEM) image of a measured cross-sectional sample, the central point in the length direction (L-axis direction) or the width direction (W-axis direction) of the dielectric layer 111 is used as a reference point, and the arithmetic mean value of the thickness of the dielectric layer 111 at 10 points spaced apart from the reference point by a predetermined interval can be obtained. The intervals of the 10 points may be adjusted depending on the scale of the scanning electron microscope (SEM) image, and may be, for example, about 1 μm to about 100 μm, about 1 μm to about 50 μm, or about 1 μm to about 10 μm. At this time, all 10 points should be positioned within the dielectric layer 111, and if all 10 points are not positioned within the dielectric layer 111, the position of the reference point may be changed, or the interval between the 10 points may be adjusted.

The capacitor body 110 may be formed by firing a stacking structure in which the plurality of dielectric layers 111 and internal electrode layers 121 and 122 are stacked.

### External Electrode

The first external electrode 131 and the second external electrode 132 are provided with voltages of different polarities and may be electrically connected with exposed portions of the first internal electrode layer 121 and the second internal electrode layer 122, respectively.

According to the above configuration, when a predetermined voltage is applied to the first external electrode 131 and the second external electrode 132, charges are accumulated between the first internal electrode layer 121 and the second internal electrode layer 122 facing each other. At this time, the capacitance of the multilayer ceramic capacitor 100 is proportional to the overlapping area of the first internal electrode layer 121 and the second internal electrode layer 122 that overlap each other along the T-axis direction in the active region.

The first external electrode 131 and the second external electrode 132 may include, respectively, first and second connection portions disposed on the third and fourth surfaces of the capacitor body 110 and connected to the first internal electrode layer 121 and the second internal electrode layer 122, and first and second band portions disposed on edges where the third and fourth surfaces of the capacitor body 110 meet the first and second surfaces or the fifth and sixth surfaces.

The first and second band portions may extend, respectively, from the first and second connection portions to portions of the first and second surfaces of the capacitor body 110 or the fifth and sixth surfaces. The first and second band portions may serve to improve the adhesion strength of the first external electrode 131 and the second external electrode 132.

Each of the first external electrode 131 and the second external electrode 132 may include a sintered metal layer in contact with the capacitor body 110, a conductive resin layer disposed to cover the sintered metal layer, and a plating layer disposed to cover the conductive resin layer.

The sintered metal layer may include the conductive metal and glass.

The conductive metal may include one or more selected from the group consisting of copper (Cu), nickel (Ni), silver (Ag), palladium (Pd), gold (Au), platinum (Pt), tin (Sn), tungsten (W), titanium (Ti), lead (Pb), and an alloy thereof, for example, copper (Cu) may include a copper (Cu) alloy. When the conductive metal includes copper (Cu), metals other than copper (Cu) may be included in an amount of less than or equal to about 5 parts by mole based on 100 parts by mole of copper (Cu).

The glass may include a composition of mixed oxides, for example, one or more selected from the group consisting of silicon oxide, boron oxide, aluminum oxide, transition metal oxide, alkali metal oxide, and alkaline earth metal oxide. The transition metal may be selected from the group consisting of zinc (Zn), titanium (Ti), copper (Cu), vanadium (V), manganese (Mn), iron (Fe) and nickel (Ni), the alkali metal may be selected from the group consisting of lithium (Li), sodium (Na) and potassium (K), and the alkaline-earth metal may be at least one selected from magnesium (Mg), calcium (Ca), strontium (Sr), and barium (Ba).

Optionally, the conductive resin layer may be formed on the sintered metal layer, and for example, may be formed in the shape that completely covers the sintered metal layer. Meanwhile, the first external electrode 131 and the second external electrode 132 may not include the sintered metal layer, and in this case, the conductive resin layer may directly contact the capacitor body 110.

The conductive resin layer extends to the first and second surfaces or the fifth and sixth surfaces of the capacitor body 110, and the length of the region (i.e., band portion) where the conductive resin layer is extended and disposed to the first and second surfaces or the fifth and sixth surfaces of the capacitor body 110 may be longer than the length of the region (i.e., band portion) where the sintered metal layer is extended and disposed to the first and second surfaces or the fifth and sixth surfaces of the capacitor body 110. That is, the conductive resin layer may be formed on the sintered metal layer, and may be formed in the shape that completely covers the sintered metal layer.

The conductive resin layer may include a resin and a conductive metal.

The resin included in the conductive resin layer may be implemented by a material which has adhesive properties and shock absorption properties and is able to form a paste when mixed with the conductive metal powder, but is not limited thereto. For example, the resin may include at least one selected from the group consisting of a phenolic resin, an acrylic resin, a silicone resin, an epoxy resin, and a polyimide resin.

The conductive metal included in the conductive resin layer serves to be electrically connected to the first internal electrode layer 121 and the second internal electrode layer 122 or the sintered metal layer.

The conductive metal included in the conductive resin layer may have a spherical shape, a flake shape, or a combination thereof. That is, the conductive metal may be formed only in flake form, only in spherical form, or in a mixed form of flake form and spherical form.

Here, the spherical shape may also include a shape that is not a perfect spherical shape, for example, a shape in which the length ratio of the major axis and the minor axis (major axis/minor axis) is less than or equal to about 1.45. The flake shape powder refers to a powder with a flat and elongated shape, and is not particularly limited. But for example, the length ratio of the major axis and the minor axis (major axis/minor axis) may be greater than or equal to about 1.95.

The first external electrode 131 and the second external electrode 132 may further include the plating layer disposed outer surface the conductive resin layer.

The plating layer may include nickel (Ni), copper (Cu), tin (Sn), palladium (Pd), platinum (Pt), gold (Au), silver (Ag), tungsten (W), titanium (Ti), or lead (Pb), either alone or in an alloy thereof. For example, the plating layer may be a nickel (Ni) the plating layer or a tin (Sn) the plating layer, may be a form in which the nickel (Ni) the plating layer and the tin (Sn) the plating layer are sequentially stacked, or may be a form in which the tin (Sn) the plating layer, the nickel (Ni) the plating layer, and the tin (Sn) the plating layer are sequentially stacked. In addition, the plating layer may include a plurality of nickel (Ni) the plating layers and/or a plurality of tin (Sn) the plating layers.

The plating layer may improve mountability to the substrate, structural reliability, durability to the outer surface, heat resistance, and equivalent series resistance (ESR) of the multilayer capacitor 100.

### Method for Manufacturing Multilayer Ceramic Capacitor

Hereinafter, a method of manufacturing the multilayer ceramic capacitor 100 according to some embodiments will be described.

A multilayer ceramic capacitor 100 according to some embodiments may be manufactured by mixing nickel (Ni) and tantalum (Ta)-based raw materials to prepare a conductive paste; manufacturing a dielectric green sheet using a dielectric slurry, and printing the conductive paste on a surface of the dielectric green sheet to form a conductive paste layer; manufacturing a dielectric green sheet stack by stacking the dielectric green sheet on which the conductive paste layer is formed; firing the dielectric green sheet stack to manufacture a capacitor body including a plurality of dielectric layers and a plurality of internal electrode layers stacked with the dielectric layers interposed therebetween; and forming an external electrode on an outer surface of the capacitor body.

The conductive paste may be prepared by mixing the nickel (Ni) and tantalum (Ta)-based raw materials.

The tantalum (Ta)-based raw material may include at least one selected from tantalum (Ta) and tantalum (Ta) oxide. The tantalum (Ta) oxide may include at least one selected from Ta₂O₅ and TaO₂.

In the firing process of the conductive paste, some of Ta₂O₅ may chemically react with Ni to form NiTa₂O₆, but some thereof may move to the surface of the internal electrode layer to form an insulating layer at the interface between the dielectric layer and the internal electrode layer.

The tantalum (Ta)-based raw material may be mixed in an amount of about 0.6 parts by weight to about 12.0 parts by weight based on 100 parts by weight of nickel (Ni), for example, about 1.0 parts by weight to about 11.5 parts by weight or about 1.5 parts by weight to about 11.0 parts by weight based on 100 parts by weight of nickel (Ni). If the tantalum (Ta)-based raw material is mixed within the content ranges, the insulating layer may be formed to have an appropriate thickness to prevent formation of metal-dielectric junctions at the interface between the internal electrode layer and the dielectric layer and thus generation of defects. Accordingly, the multilayer ceramic capacitor may secure excellent high-temperature reliability and durability.

The conductive paste may be prepared by further mixing one or more conductive metals selected from the group consisting of copper (Cu), silver (Ag), palladium (Pd), gold (Au), and an alloy thereof in addition to the nickel (Ni).

Additionally, the conductive paste may be prepared by additionally mixing a conductive metal, a binder, and a solvent. Additionally, a barium titanate-based compound may be mixed together as a co-material if necessary. The co-material can act to inhibit the sintering of the conductive powder during the firing process.

According to some embodiments, after printing the conductive paste on a surface of dielectric green sheet to form a conductive paste layer, the tantalum (Ta)-based raw material is deposited on the conductive paste layer to prepare a stacking structure. The deposition may be performed in a method such as sputtering and the like.

In the step of manufacturing the dielectric green sheet, a dielectric slurry may be prepared by mixing main component powder, a barium titanate-based compound, and optionally, subcomponent powder. The subcomponent powder may be an oxide or a salt compound, or in the form of sol dispersed in an organic solvent.

In addition, the dielectric slurry may be prepared by additionally mixing additives such as a dispersant, a binder, a plasticizer, a lubricant, an antistatic agent, and a solvent.

The dispersant may include at least one selected from the group consisting of, for example, a phosphoric acid ester-based dispersant and a polycarboxylic acid-based dispersant. The dispersant may be mixed in an amount of about 0.1 part by weight to about 5 parts by weight, for example, about 0.3 parts by weight to about 3 parts by weight based on 100 parts by weight of the barium titanate-based compound. When the dispersant is mixed within the above content range, the dielectric slurry shows excellent dispersibility, and the amount of impurities included in the manufactured dielectric layer may be reduced.

The binder may include at least one selected from the group consisting of, for example, an acrylic resin, a polyvinyl butyl resin, a polyvinyl acetal resin, an ethylcellulose resin, or the like. The binder may be added in an amount of about 0.1 part by weight to about 50 parts by weight, for example, about 3 parts by weight to about 30 parts by weight, based on 100 parts by weight of the barium titanate-based compound. When the binder is mixed within the above content range, the dielectric slurry shows excellent dispersibility, and the amount of impurities included in the manufactured dielectric layer may be reduced.

The plasticizer may include at least one selected from the group consisting of, for example, a phthalic acid-based compound such as dioctyl phthalate, benzyl butyl phthalate, dibutyl phthalate, dihexyl phthalate, di(2-ethylhexyl) phthalate, and di(2-ethylbutyl) phthalate; an adipic acid-based compound such as dihexyl adipate and di(2-ethylhexyl) adipate; a glycol-based compound such as ethylene glycol, diethylene glycol, and triethylene glycol; a glycol ester-based compound such as triethylene glycol dibutyrate, triethylene glycol di(2-ethylbutyrate), and triethylene glycol di(2-ethylhexanoate); and the like. The plasticizer may be added in an amount of about 0.1 part by weight to about 20 parts by weight, for example, about 1 part by weight to about 10 parts by weight, based on 100 parts by weight of the barium titanate-based compound. When the plasticizer is mixed within the above content range, the dielectric slurry shows excellent dispersibility, and the amount of impurities included in the manufactured dielectric layer may be reduced.

The solvent may include at least one selected from the group consisting of an aqueous solvent such as water; an alcohol-based solvent such as ethanol, methanol, benzyl alcohol, and methoxyethanol; a glycol-based solvent such as ethylene glycol and diethylene glycol; a ketone-based solvent such as acetone, methyl ethyl ketone, methyl isobutyl ketone, and cyclohexanone; an ester-based solvent such as butyl acetate, ethyl acetate, carbitol acetate, and butylcarbitol acetate; an ether-based solvent such as methyl cellosolve, ethyl cellosolve, butyl ether, and tetrahydrofuran; an aromatic-based solvent such as benzene, toluene, and xylene, or the like. The solvent may be, for example, an alcohol-based solvent or aromatic-based solvent, considering solubility or dispersibility of various additives included in the dielectric slurry. The solvent may be mixed in an amount of about 50 parts by weight to about 1000 parts by weight, and for example, about 100 parts by weight to about 500 parts by weight based on 100 parts by weight of the barium titanate-based compound. When the solvent is mixed within the above content range, the dielectric slurry components may be sufficiently mixed, and subsequent removal of the solvent is easy.

The dielectric slurry described above may be mixed by using a wet ball mill or a stirred mill. When using the zirconia balls in the wet ball mill, a plurality of zirconia balls with a diameter of about 0.1 mm to about 10 mm may be used for wet mixing for about 8 hours to about 48 hours, or about 10 hours to about 24 hours.

The prepared dielectric slurry is formed into a dielectric layer after firing.

As a method of molding the prepared the dielectric slurry into a sheet shape, a tape molding method such as a doctor blade method, a calendar roll method, etc. may be used, for example, an on-roll molding coater with a head discharge method, and a dielectric green sheet may be obtained by drying the molded body afterward.

In the manufacturing of the dielectric green sheet, a dielectric slurry may be prepared by mixing a barium titanate-based compound as a main component powder and optionally a subcomponent powder.

Next, a dielectric green sheet stack is manufactured by stacking a plurality of layers of dielectric green sheets on which internal electrode patterns are formed, and then pressing the plurality of layers of dielectric green sheets in the stacking direction. At this time, the dielectric green sheet and the internal electrode pattern may be stacked so that the dielectric green sheet is disposed on the upper and lower surfaces of the dielectric green sheet stack in the stacking direction.

The cutting of the manufactured dielectric green sheet stack to a predetermined size by dicing or the like may optionally be performed.

Additionally, the dielectric green sheet stack may be solidified and dried to remove plasticizers, etc., if necessary, and after solidified and dried, the dielectric green sheet stack may be barrel polished using a horizontal centrifugal barrel machine, and the like. In barrel polishing, the dielectric green sheet stack is placed into a barrel container with media and polishing liquid, and rotational motion or vibration is applied to the barrel container, thus unnecessary parts, such as burrs generated during cutting, may be polished. Additionally, after barrel polishing, the dielectric green sheet stack may be washed with a cleaning solution such as water, and dried.

Subsequently, the capacitor body may be prepared after binder removal treatment (calcining) and firing of the dielectric green sheet stack.

The conditions for binder removal may be appropriately adjusted depending on the components of the dielectric layer or the internal electrode layer. For example, the rate of temperature rise during binder removal treatment may be about 5° C./hour to about 300° C./hour, the support temperature may be about 180° C. to about 400° C., and the temperature holding time may be about 0.5 hour to about 24 hours. The binder removal may be performed under an air atmosphere or a reducing atmosphere.

The conditions of the firing treatment may be appropriately adjusted depending on the main component composition of the dielectric layer or the main component composition of the internal electrode layer. For example, the firing may be performed at a temperature of about 1100° C. to about 1400° C., for example, at a temperature of about 1200° C. to about 1350° C. Additionally, the firing may be performed for about 0.5 to about 8 hours, for example, about 1 to about 3 hours. Additionally, the firing may be performed in a reducing atmosphere, for example, in a humidified mixed gas of nitrogen and hydrogen, and may be performed under conditions such as a hydrogen concentration of less than or equal to about 1.0%. When the internal electrode layer includes nickel (Ni) or a nickel (Ni) alloy, an oxygen partial pressure under the firing atmosphere may be about 1.0×10⁻¹⁴ MPa to about 1.0×10⁻¹⁰ MPa.

After firing, annealing may be performed as needed. The annealing is a treatment to re-oxidize the dielectric layer, and annealing may be performed if firing is performed in a reducing atmosphere. The conditions of the annealing treatment may also be appropriately adjusted depending on the components of the dielectric layer. For example, the annealing temperature may be about 950° C. to about 1150° C., the time may be about 0 to about 20 hours, and the rate of temperature rise may be about 50° C./hour to about 500° C./hour. The annealing atmosphere may be a humidified nitrogen gas (N₂) atmosphere, and an oxygen partial pressure may be about 1.0×10⁻⁹ MPa to about 1.0×10⁻⁵ MPa.

In binder removal treatment, firing treatment, or annealing treatment, for example, a wetter may be used to humidify nitrogen gas or mixed gas. In this case, the water temperature may be about 5° C. to about 75° C. The binder removal treatment, firing treatment, and annealing treatment may be performed sequentially or independently.

Optionally, surface treatment such as sand blasting, laser irradiation, barrel polishing, etc. may be performed on the third and fourth surfaces of the prepare capacitor body 110. By performing this surface treatment, the ends of the first internal electrode layer and the second internal electrode layer may be exposed to the outermost surfaces of the third and fourth surfaces, and thus the electrical connection between the first external electrode layer and the second external electrode layer, and the first internal electrode and the second internal electrode may be improved, alloy portions may be easily formed.

Subsequently, the external electrode is formed on the one surface of the manufactured capacitor body 110.

As an example, a paste for forming the sintered metal layer may be applied to the external electrode and then sintered to form the sintered metal layer.

The paste for forming the sintered metal layer may include the conductive metal and glass. Since the description of the conductive metal and glass is the same as described above, repetitive description will be omitted. Additionally, the paste for forming the sintered metal layer may optionally include a binder, solvent, dispersant, plasticizer, oxide powder, and the like. The binder may be, for example, ethylcellulose, acrylic, butyral, etc., and the solvent may be, for example, an organic solvent or aqueous solvent such as terpineol, butylcarbitol, alcohol, methyl ethyl ketone, acetone, toluene, and the like.

Methods for applying the paste for forming the sintered metal layer on the outer surface of the capacitor body 110 may include various printing methods such as dip method and screen printing, application method using a dispenser, etc., and spraying method using spray. The paste for forming the sintered metal layer may be applied to at least the third and fourth surfaces of the capacitor body 110, and optionally applied to a part of the first, second, fifth, or the sixth surfaces on which the band portions of the first and second external electrodes are formed.

Thereafter, the capacitor body 110 applied with the paste for forming the sintered metal layer is dried, and sintered at a temperature of about 700° C. to about 1000° C. for about 0.1 hour to about 3 hours, to form the sintered metal layer.

Optionally, a paste for forming the conductive resin layer is applied on an outer surface of the obtained capacitor body 110 and then cured, to form the conductive resin layer.

The paste for forming the conductive resin layer may include a resin and, optionally, a conductive metal or a non-conductive filler. Since the description of the conductive metal and resin is the same as described above, repetitive description will be omitted. Additionally, the paste for forming the conductive resin layer may optionally include a binder, a solvent, a dispersant, a plasticizer, an oxide powder, and the like. The binder may include, for example, ethylcellulose, acrylic, butyral, etc., and the solvent may be an organic solvent or aqueous solvent such as terpineol, butylcarbitol, alcohol, methyl ethyl ketone, acetone, and toluene.

For example, the conductive resin layer may be formed by dipping the capacitor body 110 in the paste for forming the conductive resin layer and then curing it, or by printing the paste for forming the conductive resin layer on the surface of the capacitor body 110 by a screen-printing method or a gravure printing method, or by applying the paste for forming the conductive resin layer to the surface of the capacitor body 110 and then curing it.

Next, the plating layer may be formed on the outer surface of the conductive resin layer.

For example, the plating layer may be formed by a plating method, sputtering, or electrolytic plating (electric deposition).

Hereinafter, the embodiments are illustrated in more detail with reference to examples. However, these examples are exemplary, and the scope of claims is not limited thereto.

### (Manufacturing of Multilayer Ceramic Capacitors)

### Examples 1 to 6 and Reference Examples 1 to 3

A conductive paste was prepared by mixing nickel (Ni) and tantalum pentoxide (Ta₂O₅) nanoparticles in the contents shown in Table 1.

Next, a dielectric slurry was prepared using barium titanate (BaTiO₃) powder. At this time, the dielectric slurry was prepared by mechanical milling after adding ethanol/toluene, a dispersant, and a binder together using zirconia balls (ZrO₂ balls) as a dispersion medium.

Subsequently, the prepared dielectric slurry was used to manufacture a dielectric green sheet by using a head discharge type on-roll forming coater. The conductive paste prepared above was printed on the surface of the dielectric green sheet to form a conductive paste layer.

A dielectric green sheet stack was manufactured by stacking and pressing dielectric green sheets having a conductive paste layer formed thereon.

The dielectric green sheet stack was calcinated at 400° C. or less under a nitrogen atmosphere and fired at 1300° C. or less at a hydrogen (H₂) concentration of 1.0% or less.

Subsequently, a multilayer ceramic capacitor was manufactured through processes of an external electrode, plating, or the like.

### Comparative Example 1

A multilayer ceramic capacitor was manufactured in the same manner as in Example 1 except that the conductive paste was prepared without using the tantalum pentoxide (Ta₂O₅) nano particles. The content of Ta₂O₅ based of 100 parts by weight of Ni was expressed in Table 1.

TABLE 1

| | Content of Ta₂O₅ (parts by weight) |
|---|---|
| Comparative Example 1 | 0 |
| Example 1 | 0.9 |
| Example 2 | 1.8 |
| Example 3 | 2.7 |
| Example 4 | 3.6 |
| Example 5 | 5.4 |
| Example 6 | 10.8 |
| Reference Example 1 | 0.54 |
| Reference Example 2 | 12.6 |
| Reference Example 3 | 18 |

### Evaluation 1: Insulating Layer Thickness

The multilayer ceramic capacitors according to Examples 1 to 6, Reference Examples 1 to 3, and Comparative Example 1 were subjected to TEM (transmission electron microscope) analysis in the following method to measure a thickness of each insulating layer. The results are shown in Table 2.

The multilayer ceramic capacitor was placed into an epoxy mixing solution and cured, and the W-axis and T-axis direction surface (WT surface) of each capacitor body was polished to a depth of ½ in the L-axis direction and then, fixed and maintained in a vacuum atmosphere chamber to obtain cross-sectional samples to observe an active region where a dielectric layer and an internal electrode layer intersect each other. Next, it was measured using a transmission electron microscope (TEM) so that at least 1 layer, 3 layers, 5 layers, or 10 layers of the internal electrode layers for the active region of the cross-sectional sample were visible. TEM was measured under conditions of an acceleration voltage of 200 kV using a Xe-FIB (focused ion beam). In a scanning electron microscope (SEM) image of a measured cross-sectional sample, the central point in the length direction (L-axis direction) or the width direction (W-axis direction) of the insulating layer was used as a reference point, and the arithmetic mean value of the thickness of the insulating layer at 10 points spaced apart from the reference point by a predetermined interval was obtained.

### Evaluation 2: TEM-EDS Analysis

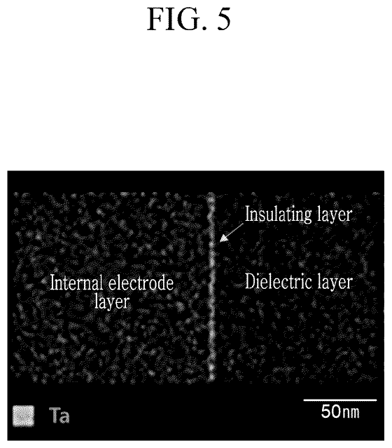

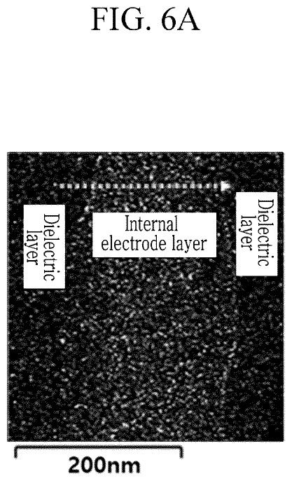

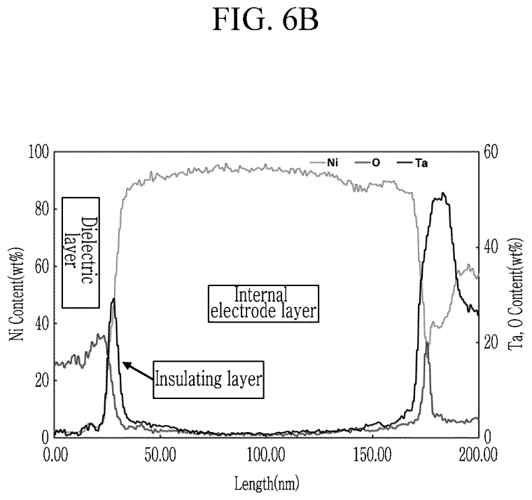

The multilayer ceramic capacitor of Example 1 was subjected to TEM-EDS (Transmission Electron Microscopy-Energy Dispersive Spectroscopy) analysis, and the results are shown in FIGS. 5 and 6.

The multilayer ceramic capacitor manufactured in Example 1 was placed into an epoxy mixing solution and cured, and the W-axis and T-axis direction surface (WT surface) of each capacitor body was polished to a depth of ½ in the L-axis direction and then, fixed and maintained in a vacuum atmosphere chamber to obtain cross-sectional samples to observe an active region where a dielectric layer and an internal electrode layer intersect each other. Subsequently, the active region of the cross-sectional sample was divided into three portions such as an upper portion, a central portion, and a lower portion and then, take an image of with a transmission electron microscope (TEM), so that at least one dielectric layer and one internal electrode layer was visible in the central portion. TEM was measured under conditions of an acceleration voltage of 200 kV by using a Xe-FIB (focused ion beam). Subsequently, the TEM image of the cross-sectional sample was subjected to EDS (energy dispersive spectroscopy) mapping analysis, and in addition, an EDS (energy dispersive spectroscopy) line analysis was performed on a straight line section from one point of the dielectric layer to another point of the internal electrode layer adjacent to the dielectric layer to confirm a structure and a component of the internal electrode layer.

FIG. 5 is a TEM-EDS (transmission electron microscopy-energy dispersive spectroscopy) mapping analysis photograph of the active region according to Example 1, and FIGS. 6A and 6B are an image and a graph of TEM-EDS (transmission electron microscopy-energy dispersive spectroscopy) line profile analysis diagram for the active region according to Example 1.

Referring to FIGS. 5 to 6B, in Example 1, it was confirmed that an insulating layer including tantalum (Ta) was formed at the interface between the internal electrode layer and the dielectric layer, and in the insulating layer, an oxide including the tantalum (Ta) was present. Specifically, the TEM-EDS line analysis result showed that a region having a maximum atomic % of nickel (Ni) was present in the metal layer of the internal electrode layer, and a region having a maximum atomic % of tantalum (Ta) present in the insulating layer positioned at the interface between the internal electrode layer and the dielectric layer. In addition, the tantalum (Ta) was present in a higher content in the insulating layer than in the metal layer of the internal electrode layer.

### Evaluation 3: XRD Analysis

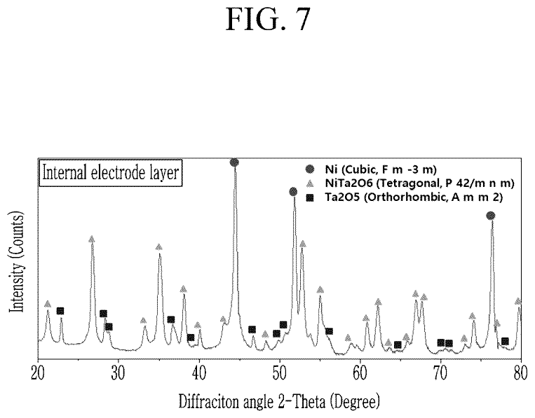

The internal electrode layer of the multilayer ceramic capacitor of Example 1 was subjected to X-ray diffraction (XRD) analysis, and the results are shown in FIG. 7.

Specifically, after the multilayer ceramic capacitor was put in an epoxy mixing solution and cured, a W-axis and T-axis direction surface (WT surface) of its capacitor body was polished to a ½ depth in a L-axis direction and maintained in a vacuum atmosphere chamber, obtaining a cross-sectional sample to examine an active region where the dielectric layer and internal electrode layer intersect each other. Subsequently, when the active region of a cross-sectional sample was divided into three portions such as an upper portion, a central portion, and a lower portion, an internal electrode layer in the central portion was subjected to X-ray diffraction (XRD) analysis by using Cu K_{α} rays to check a material composition of the internal electrode layer.

FIG. 7 is an X-ray diffraction analysis (XRD) graph for the internal electrode layer according to Example 1.

Referring to FIG. 7, in Example 1, it was confirmed that Ta₂O₅ and NiTa₂O₆ were present in the internal electrode layer. Accordingly, the results of FIGS. 5 to 7 show that Ta was present in the form of oxides such as Ta₂O₅, NiTa₂O₆, and the like in the insulating layer positioned at the interface between the internal electrode layer and the dielectric layer.

### Evaluation 4: High-Temperature Reliability

The multilayer ceramic capacitors according to Examples 1 to 6 and Comparative Example 1 were measured with respect to capacitance and mean time to failure (MTTF) in the following method, and the results are shown in Table 2.

The capacitance was measured as capacitance (F) at a frequency of 1 kHz and a voltage of 0.5 V.

MTTF (mean time to failure) was measured by calculating an average failure time (hr) under conditions of a temperature of 125° C., a voltage of 9.45 V, and 48 hours.

In Table 2, the capacitance and MTTF were expressed as each ratio to the results of Comparative Example 1.

TABLE 2

| | Average thickness of | | |
|---|---|---|---|
| | insulating layer (nm) | Capacitance | MTTF |
| Comparative Example 1 | 0 | 1.0 | 1 |
| Example 1 | 0.5 | 1.0 | 1.98 |
| Example 2 | 1.0 | 1.0 | 2.87 |
| Example 3 | 1.5 | 1.0 | 2.95 |
| Example 4 | 2.0 | 1.0 | 2.95 |
| Example 5 | 3.0 | 1.0 | 2.98 |
| Example 6 | 6.0 | 1.0 | 2.92 |
| Reference Example 1 | 0.3 | 1.0 | 0.93 |
| Reference Example 2 | 7.0 | 0.93 | 2.67 |
| Reference Example 3 | 10.0 | 0.86 | 2.71 |

Referring to Table 2, the multilayer ceramic capacitors of Examples 1 to 6, compared with that of Comparative Example 1, exhibited excellent capacitance and high-temperature reliability. Accordingly, a multilayer ceramic capacitor including the internal electrode layer having an insulating layer disposed at the interface with a dielectric layer and made of an oxide including Ta, exhibited excellent high-temperature reliability and durability.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

### DESCRIPTION OF SYMBOLS

100: multilayer ceramic capacitor
110: capacitor body
111: dielectric layer
121: first internal electrode layer
121a: first metal layer
121b: first insulating layer
122: second internal electrode layer
122a: second metal layer
122b: second insulating layer
131: first external electrode
132: second external electrode

What is claimed is:

1. A multilayer ceramic capacitor, comprising
a capacitor body including a plurality of dielectric layers and a plurality of internal electrode layers stacked with the dielectric layers interposed therebetween; and
an external electrode disposed on an outer surface of the capacitor body,
wherein at least one of the plurality of internal electrode layers includes a metal layer and an insulating layer disposed at an interface with the dielectric layer on a surface of the metal layer,
the insulating layer includes an oxide including tantalum (Ta), and
the oxide is represented by Chemical Formula 1: 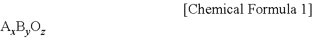
wherein, in Chemical Formula 1,
A includes Ni, B includes Ta, 0≤x≤0.2, 0.2≤y≤0.5, and x+y+z=1.

2. The multilayer ceramic capacitor of claim 1, wherein
the oxide includes at least one selected from the group consisting of Ta₂O₅, TaO₂, and NiTa₂O₆.

3. The multilayer ceramic capacitor of claim 1, wherein
the metal layer includes nickel (Ni) and/or tantalum (Ta).

4. The multilayer ceramic capacitor of claim 3, wherein
a content of tantalum (Ta) in the insulating layer is higher than a content of Ta in the metal layer.

5. The multilayer ceramic capacitor of claim 3, wherein
when a content of tantalum (Ta) included in the insulating layer is X and a content of tantalum (Ta) included in the metal layer is Y, Equation 1 is satisfied:
$$0 < ( \vert X - Y \vert ) / X \leq 1. \qquad [ Equation 1 ]$$

6. The multilayer ceramic capacitor of claim 3, wherein
the metal layer includes greater than 0 and less than or equal to 15 parts by atom of tantalum (Ta) based on 100 parts by atom of nickel (Ni).

7. The multilayer ceramic capacitor of claim 1, wherein
the insulating layer includes tantalum (Ta) in an amount of 30 atomic % to 100 atomic % based on a total amount of the insulating layer.

8. The multilayer ceramic capacitor of claim 1, wherein
an average thickness of the insulating layer is 0.5 nm to 6.0 nm.

9. The multilayer ceramic capacitor of claim 1, wherein
the insulating layer is disposed at the interface with the dielectric layer in the stacking direction in the plurality of internal electrode layers.

10. The multilayer ceramic capacitor of claim 1, wherein
the insulating layer is disposed at the interface with the dielectric layer in a direction perpendicular to the stacking direction in the plurality of internal electrode layers.

11. The multilayer ceramic capacitor of claim 1, wherein
the insulating layer is disposed at the interface with the dielectric layer in the stacking direction and in the direction perpendicular to the stacking direction in the plurality of internal electrode layers.

12. The multilayer ceramic capacitor of claim 1, wherein
the insulating layer is further disposed at an interface with the external electrode in a direction perpendicular to the stacking direction in the plurality of internal electrode layers.

13. The multilayer ceramic capacitor of claim 1, wherein
when measuring an atomic % of tantalum (a) by analyzing a TEM-EDS (Transmission Electron Microscopy-Energy Dispersive Spectroscopy) line along a straight line from a point in the dielectric layer to a point in the plurality of internal electrode layers adjacent to the dielectric layer,
a maximum atomic % of tantalum (Ta) is in the insulating layer.

14. A method for manufacturing a multilayer ceramic capacitor, comprising
mixing nickel (Ni) and tantalum (Ta)-based raw materials to prepare a conductive paste;
manufacturing a dielectric green sheet using a dielectric slurry,
printing the conductive paste on a surface of the dielectric green sheet to form a conductive paste layer;
manufacturing a dielectric green sheet stack by stacking the dielectric green sheet on which the conductive paste layer is formed;
firing the dielectric green sheet stack to manufacture a capacitor body including a plurality of dielectric layers and a plurality of internal electrode layers stacked with the dielectric layers interposed therebetween; and
forming an external electrode on an outer surface of the capacitor body,
wherein at least one of the plurality of internal electrode layers includes a metal layer and an insulating layer disposed at an interface with the dielectric layer on a surface of the metal layer, and the insulating layer includes an oxide represented by Chemical Formula 1 and including tantalum (Ta): 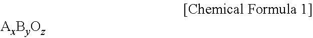
wherein, in Chemical Formula 1,
A includes Ni, B includes Ta, 0≤x≤0.2, 0.2≤y≤0.5, and x+y+z=1.

15. The method of claim 14, wherein
the tantalum (Ta)-based raw material includes at least one selected from the group consisting of tantalum (Ta) and tantalum (Ta) oxide, and
the tantalum (Ta) oxide includes at least one selected from the group consisting of Ta₂O₅ and TaO₂.

16. The method of claim 14, wherein
the tantalum (Ta)-based raw material is mixed in an amount of 0.6 part by weight to 12.0 parts by weight based on 100 parts by weight of nickel (Ni).
